(19) United States
(12) Patent Application Publication
(10) Pub. No.: US 2024/0159878 A1
(43) Pub. Date: May 16, 2024

(54) RANGE DETECTION DEVICE AND METHOD FOR RANGE DETECTION THEREOF

(71) Applicant: Seer Microelectronics, Inc., Hsinchu County (TW)

(72) Inventor: Chih-Wei Lai, Hsinchu County (TW)

(21) Appl. No.: 18/389,232

(22) Filed: Nov. 14, 2023

Related U.S. Application Data
(60) Provisional application No. 63/383,996, filed on Nov. 16, 2022.

(51) Int. Cl. G01S 7/4861; G01S 17/10

(52) U.S. Cl. CPC G01S 7/4861; G01S 17/10

(57) ABSTRACT

A range detection device and a method for range detection thereof are disclosed. An optical sensing element receives a reflected signal of external light signal for triggering a transformation element to generate an electrical signal of receiving detection. Range detection data are generated to an operation processing unit according to the electrical signal of receiving detection and an electrical signal of reference. A plurality of first item data of the range detection data are compressed and operated to generate a plurality of first operation data to be stored as stored data. Further, the first item data correspond to a plurality of first storage addresses. The first operation data correspond to a plurality of second storage addresses. A first address amount of the first storage addresses is greater than a second address amount of the second storage addresses. Thereby, more storage addresses will be spared and hence extending the detection range.

### FIELD OF THE INVENTION

The present application related to a detection device and a method thereof, in particular to a range detection device and a method for range detection thereof.

### BACKGROUND OF THE INVENTION

With the evolution of technology, electronic devices have developed into more diversified application designs based on life needs. In order to improve the safety, convenience, and even entertainment of life, the range detection technology, for example, the time-of-flight (TOF) technology, has become an indispensable part.

At present, the applications of TOF are extensive. It is used in consumer electronic devices, such as tablet computers and smart phones. It is also used in vehicles, such as active automatic emergency braking, and most of them adopt hydraulic brake control systems or the electronic stability program (abbreviated as ESP, also known as electronic body stability system) in conjunction with TOF.

However, the existing range detection technique faces the challenge of storage space corresponding to long detection distance. As the detection distance increases, the stored range detection data will occupy more storage addresses.

To sum up, how to provide a ranging detection technique that may reduce the storage space of range detection data is a challenge in this field.

### SUMMARY OF THE INVENTION

An objective of the present application is to provide a range detection device and a method for range detection thereof. An operation processing unit compresses and operates and a transformation element generates range detection data according to an electrical signal of receiving detection and an electrical signal of reference. Then the operation processing unit generates a plurality of first operation data correspondingly according to a plurality of first item data of the range detection data. The storage address amount occupied by the plurality of first operation data is smaller than the storage address amount occupied by the plurality of first item data. Thereby, the range detection device may use the saved storage address to store more range detection data and thud extending the detection range.

To achieve the above objective, the present application provides a method for range detection, which is applied to a range detection device for detecting an object under detect. First, an optical sensing element of the range detection device receives a reflected signal of external light signal for triggering a transformation element to generate an electrical signal of receiving detection. The transformation element generates range detection data to an operation processing unit according to the electrical signal of receiving detection and an electrical signal of reference. The range detection data include a plurality of first item data. The operation processing unit compresses and operates the plurality of first item data and generates a plurality of first operation data. The plurality of first operation data are stored as stored data of the range detection device. In addition, the plurality of first item data correspond to a plurality of first storage addresses of the range detection device. The plurality of first operation data correspond to a plurality of second storage addresses of the range detection device. A first address amount of the plurality of first storage addresses is greater than a second address amount of the plurality of second storage addresses. Thereby, according to the present application, more storage addresses will be saved and hence extending the detection range of the range detection device.

The present application provides a range detection device, which is applied for detecting an object under detect. The range detection device comprises an optical sensing element, a transformation element, and an operation processing unit. The transformation element is disposed between the optical sensing element and the operation processing unit. The optical sensing element receives a reflected signal of external light signal for triggering a transformation element to generate an electrical signal of receiving detection. The transformation element generates range detection data to an operation processing unit according to the electrical signal of receiving detection and an electrical signal of reference. The range detection data include a plurality of first item data. The operation processing unit compresses and operates the plurality of first item data and generates a plurality of first operation data. The plurality of first operation data are stored as stored data of the range detection device. In addition, the plurality of first item data correspond to a plurality of first storage addresses of the range detection device. The plurality of first operation data correspond to a plurality of second storage addresses of the range detection device. A first address amount of the plurality of first storage addresses is greater than a second address amount of the plurality of second storage addresses. Thereby, according to the present application, more storage addresses will be spared and hence extending the detection range of the range detection device.

### BRIEF DESCRIPTION OF DRAWINGS

FIG. 1 shows a flowchart of the method for range detection according to an embodiment of the present application;

FIG. 2 shows a schematic diagram of signal transmission of the range detection device according to an embodiment of the present application;

FIG. 3 shows a schematic diagram of the detection signal according to an embodiment of the present application;

FIG. 4 shows a schematic diagram of transforming detection signal to range detection data according to an embodiment of the present application;

FIG. 5A shows a schematic diagram of operating item data according to an embodiment of the present application;

FIG. 5B shows a schematic diagram of compression operation according to an embodiment of the present application;

FIG. 6 shows a schematic diagram of compression operation according to another embodiment of the present application;

FIG. 7 shows a schematic diagram of signal transmission of the range detection device according to another embodiment of the present application;

FIG. 8A shows a schematic diagram of signal transmission of the range detection device according to another embodiment of the present application; and

FIG. 8B shows a schematic diagram of signal transmission of the range detection device according to another embodiment of the present application.

### DETAILED DESCRIPTION OF THE INVENTION

In order to make the structure and characteristics as well as the effectiveness of the present application to be further understood and recognized, the detailed description of the present application is provided as follows along with embodiments and accompanying figures.

In the specifications and subsequent claims, certain words are used for representing specific devices. A person having ordinary skill in the art should know that hardware manufacturers might use different nouns to call the same device. In the specifications and subsequent claims, the differences in names are not used for distinguishing devices. Instead, the differences in functions are the guidelines for distinguishing. In the whole specifications and subsequent claims, the word “comprising” is an open language and should be explained as “comprising but not limited to”. Besides, the word “couple” includes any direct and indirect electrical connection. Thereby, if the description is that a first device is coupled to a second device, it means that the first device is connected electrically to the second device directly, or the first device is connected electrically to the second device via other device or connecting means indirectly.

To solve the problem of storage space for increasing detection range faced by the current range detection technology, the present application provides a range detection device and a method for range detection thereof. Second range detection data are generated according to first range detection data. In addition, the plurality of first item data correspond to a plurality of first storage addresses of the range detection device. The plurality of second range detection data correspond to a plurality of second storage addresses of the range detection device. A first address amount of the plurality of first storage addresses is greater than a second address amount of the plurality of second storage addresses. Thereby, the storage addresses occupied by the stored data according to the present application may be reduced thereby increasing the detection range.

In the following description, various embodiments of the present application are described using figures for describing the present application in detail. Nonetheless, the concepts of the present application may be embodied by various forms. Those embodiments are not used to limit the scope and range of the present application.

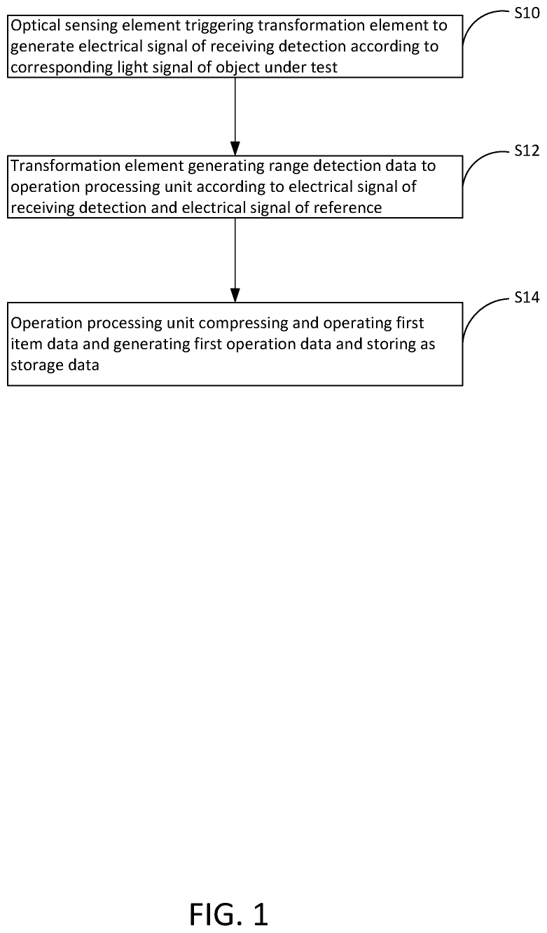

First, please refer to FIG. 1, which shows a flowchart of the method for range detection according to an embodiment of the present application. As shown in the figures, the method for range detection according to the present embodiment comprises steps of:

Step S10: Optical sensing element triggering transformation element to generate electrical signal of receiving detection according to corresponding light signal of object under detect;

Step S12: Transformation element generating range detection data to operation processing unit according to electrical signal of receiving detection and electrical signal of reference; and

Step S14: Operation processing unit compressing and operating first item data and generating first operation data and storing as stored data.

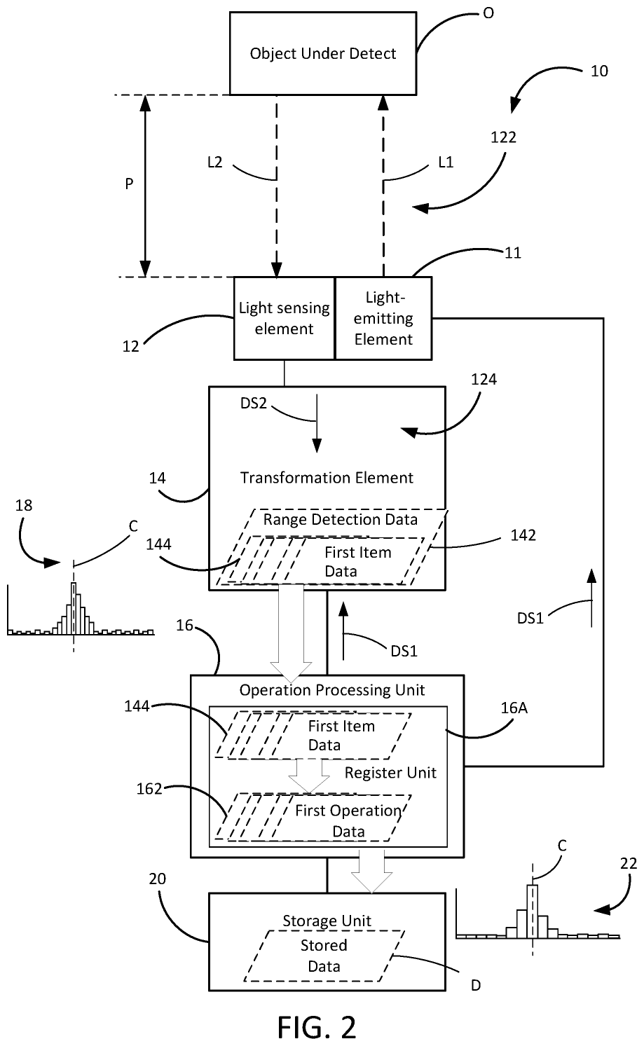

Please refer to FIG. 2, which shows a schematic diagram of signal transmission of the range detection device according to an embodiment of the present application. As shown in the figure, the range detection device 10 according to the present application comprises an optical sensing element 12, a transformation element 14, and an operation processing unit 16. The optical element 12 and the operation processing unit 16 are both coupled to the transformation element 14. The optical element 12 generates a plurality of detection signals 124 to the transformation element 14 according to a plurality of light signals 122. The transformation element 14 generates range detection data 142 to the operation processing unit 16. The operation processing unit 16 operates according to a plurality of first item data 144 of the range detection data 142 for generating a plurality of first operation data 162 and storing as stored data D. The range detection data 142 correspond to a center of mass C of a detection histogram 18. The stored data D correspond to a storage histogram 22. The storage histogram 22 includes the center of mass C. Thereby, the stored data D still correspond to the center of mass C. The address amount of the storage address used by the plurality of first item data 144 is greater than the address amount of the storage addresses used by the plurality of first operation data 162. Thereby, the operation processing unit 16 gives the plurality of first operation data 162 with less storage addresses for storage in the range detection device 10. Hence, the corresponding detection range of the range detection data 142 may be increased, as described in the following.

In the step S10, according to the present embodiment, a TOF, in particular, direct time-of-flight (DTOF), optical sensor is adopted as the optical sensing element 12. The optical sensing element 12 generates a plurality of detection signals 124 according to the plurality of light signals 122. The plurality of light signals 122 mean a plurality of reflected signals of light signals L2 or a plurality of photons received by the optical sensing element 12. The optical sensing element 12 may include, but not limited to, a complementary metal-oxide-semiconductor (CMOS) sensor, a single-photon avalanche diode (SPAD) sensor, or an avalanche photodiode (APD). Furthermore, an indirect time-of-flight (ITOF) optical sensor may be adopted. Both DTOF and ITOF need the optical sensing element 12 to sense the light signals 122 for generating the corresponding detection signals 124. The difference is that the ITOF detects the reflection light of continuous-wave light while the DTOF detects the reflection light of a plurality of light pulses.

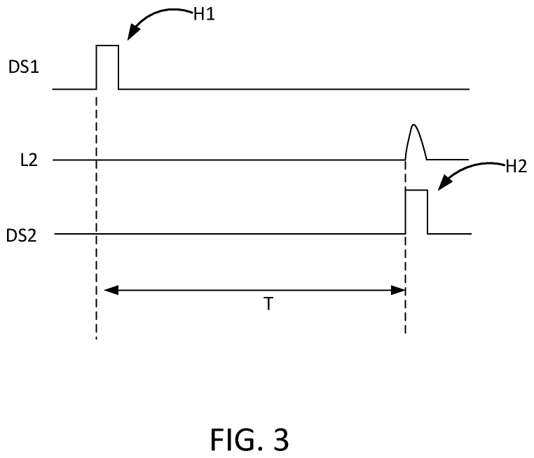

Please refer to FIG. 2 again and to FIG. 3. The range detection device 10 further comprises a light-emitting element 11. The operation processing unit 16 generates an electrical signal of reference DS1 for controlling the light-emitting element 11 to emit detection light L1 to the object under detect O and to the transformation unit 14. Next, the optical sensing element 12 receives the reflected signals of light signals L2 and triggers the transformation element 14 to generate an electrical signal of receiving detection DS2. Thereby, the transformation element 14 receives the electrical signal of reference DS1 and the electrical signal of receiving detection DS2. In addition, an external controller, such as the controller implemented by a SOC digital circuit, an FPGA, or a microcontroller unit (MCU) may be used to generate the electrical signal of reference DS1 for driving the light-emitting element 11 to emit the detection light L1 as well as providing the electrical signal of reference DS1 to the transformation element 14.

According to the present embodiment, the electrical signal of receiving detection DS2 is used to detect the plurality of detection signals of the object under detect O. Nonetheless, the present application is not limited to the embodiment. Alternatively, to be more precise, the light-emitting element 11 may generate a plurality of rays of detection light L1. Thereby, the optical sensing element 12 may receive a plurality of reflected signals of light signals correspondingly. Likewise, the numbers of the electrical signal of reference DS1 and the electrical signal of receiving detection DS2 are increased correspondingly for increasing detection precision.

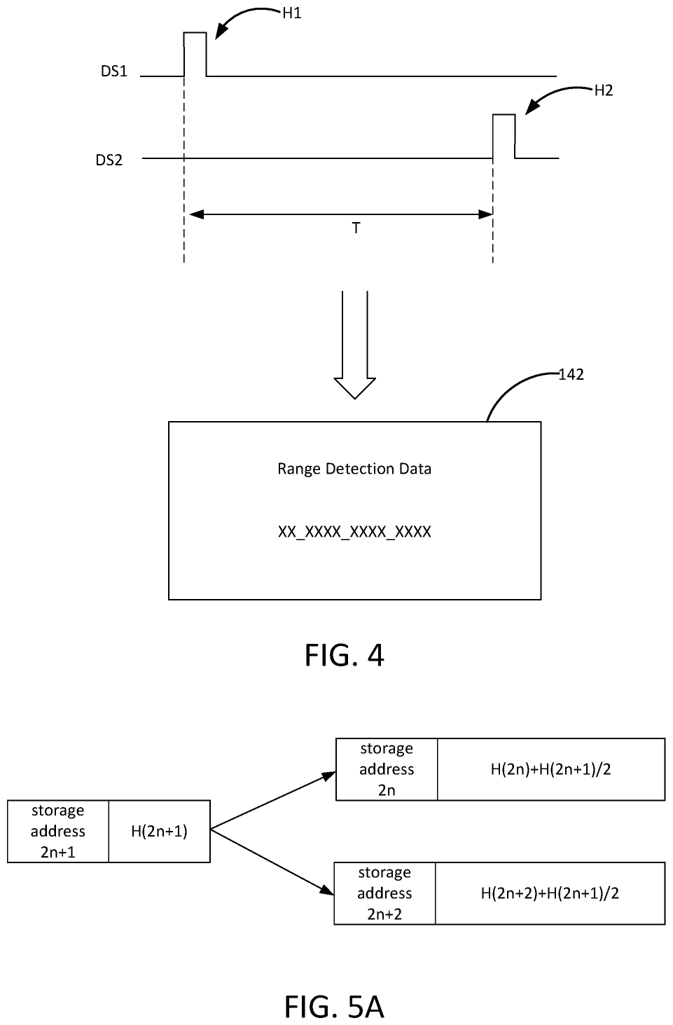

In the step 12, please refer to FIG. 2 again and to FIGS. 3 and 4. According to the present employment, the transformation element 14 generates the corresponding range detection data 142 according to the plurality of detection signals 124. A first enable voltage H1 of the electrical signal of reference DS1 and a second enable voltage H2 of the electrical signal of receiving detection are spaced by a time interval T. Furthermore, the rising edge of the first enable voltage H1 and the rising edge of the second enable voltage H2 are spaced by the time interval T. The rising edge of the reflected signal of light signal L2 corresponds to the rising edge of the second enable voltage H2. The transformation element 14 according to the present embodiment counts according to the time interval T and transforms to the range detection data 142. As shown in FIG. 4, according to the present embodiment, a 14-bit time-to-digital converter (TDC) is adopted as the transformation element 14. Thereby, the range detection data 142 according to the present embodiment are 14-bit TDC data. For example, the TDC converts the time interval between two pulse signals to the 14-bit TDC data. By converting the time interval T between the electrical signal of reference DS1 and the electrical signal of receiving detection DS2 to the 14-bit TDC data, the 14-bit XX_XXXX_XXXX_XXXX may be 00_0000_0000_0000^{˜}11_1111_1111_1111, which may be used to representing the range detection data 142. In the DTOF technology, the range detection data 142 correspond to 14-bit histogram data, as the detection histogram 18 in FIG. 2. In other words, the time interval between the electrical signal of reference DS1 and the electrical signal of receiving detection DS2 is converted to least-significant-bit (LSB) data for facilitating subsequent data processing. The 14-bit data as described above are an example. The present application is not limited to the embodiment. According to the requirements in detection range P, the data may be 5-bit, 14-bit, or even 128-bit instead.

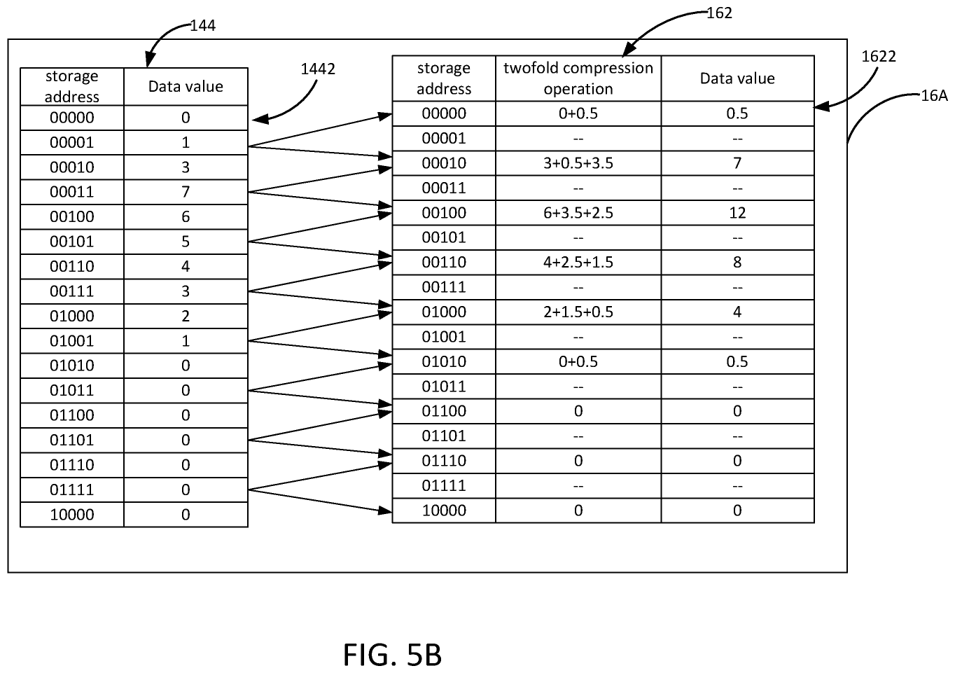

In the step S14, please refer to FIG. 2 and FIG. 5A. The operation processing unit 16 receives the range detection data 142 and operates the plurality of first item data 144 of the range detection data 142 for giving the plurality of first operation data 162. To elaborate, the operation processing unit 16 executes a compression operation. According to the present embodiment, the operation processing unit 16 moves the odd items of the plurality of first item data 144 to the storage addresses of the even items of the plurality of first item data 144 for achieving twofold compression. The operation principle is to extract the center of mass C in the detection histogram 18 and the storage histogram 22, as the following equation:

$$C = \frac{{\sum }_{i = 0}^{N} ( i \times H ( i ) )}{{\sum }_{i = 0}^{N} H ( i )} \qquad ( 1 )$$

C is the center of mass; i×H(i) are the item data; i is the storage address; H(i) is the data value. Thereby, the odd item data are expressed as (2n+1)×H(2n+1). The data value of the even item data at the storage address 2n is H(2n). Thereby, the data are expressed as (2n)×H(2n). The data value at the storage address 2n+2 are H(2n+2). Thereby, the data are expressed as (2n+2)×H(2n+2). As shown in FIG. 5A, the twofold compression operation according to the present embodiment is that the operation processing unit 16 divides the odd item data into two H(2n+1)/2 and store them in the storage addresses 2n and 2n+2 of the even item data, respectively. Thereby, the storage address 2n+1 originally used for storing the odd item data of the plurality of first item data 144 will be spared. Nonetheless, the compressed data require additional bits for storing the integer term and the decimal term.

As shown in FIG. 5B, according to the present embodiment, the storage addresses are 5-bit addresses. The plurality of first item data 144 are [0, 1, 3, 7, 6, 5, 4, 3, 2, 1, 0, 0, 0, 0, 0, 0, 0], which are stored at the first storage address 1442 from [00000] to [10000]. The operation processing unit 16 executes a twofold compression operation on the plurality of first item data 144. The twofold compression operation is to move the odd item data of the plurality of first item data 144 to the storage addresses of the even item data. At this time, the plurality of first operation data 162 are [0.5, 7, 12, 8, 4, 0.5, 0, 0, 0]. Thereby, the second storage addresses 1622 occupied by the plurality of first operation data 162 are approximately one half of the first storage addresses 1442 occupied by the plurality of first item data 144. Nonetheless, the present application is not limited to the embodiment. The compression ratio may be set according to applications. For example, twofold to 16-fold compression may be adopted. The plurality of first item data 144 are registered in a register unit 16A of the operation processing unit 16 for the operation processing unit 16 to perform compression operation, generate the plurality of first operation data 162, and register them in the register unit 16A. Thereby, the operation processing unit 16 stores the plurality of first operation data 162 as the stored data D in a storage unit 20, for example, a flash memory, a cache memory, a static random-access memory, or a solid-state disk. The operation processing unit 16 as described above may be implemented by a System on chip (SOC) digital circuit, an FPGA, or a microcontroller unit (MCU).

For example, the plurality of first item data 144 are 16384 item data with each item being 10 bits. After twofold compression, they reduce to 8192 item data approximately with each item being 12 bits. In other words, after twofold compression, an additional bit will be used for storing the integer term and another additional bit will be used for storing the decimal term. Thereby, 163840 bits of data will be compressed to 98304 bits of data approximately. With the compression ratio of address amount of 60%, 40% of storage addresses is spared. The spared storage addresses may be used for storing the plurality of first operation data 162 corresponded to the increased detection range P. For the compression ratio of address amount, the twofold compression increases 1.67 times (namely, 1/(60%)=1.67) of the range detection data 142. That is to say, the detection range may be increased by 1.67 times. Thereby, given the condition of not increasing the memory space, the detection range P of the optical sensing element 12 may be increased. In other words, the ratios of storage address amount before and after operation corresponds to the detection range P of the range detection device 10.

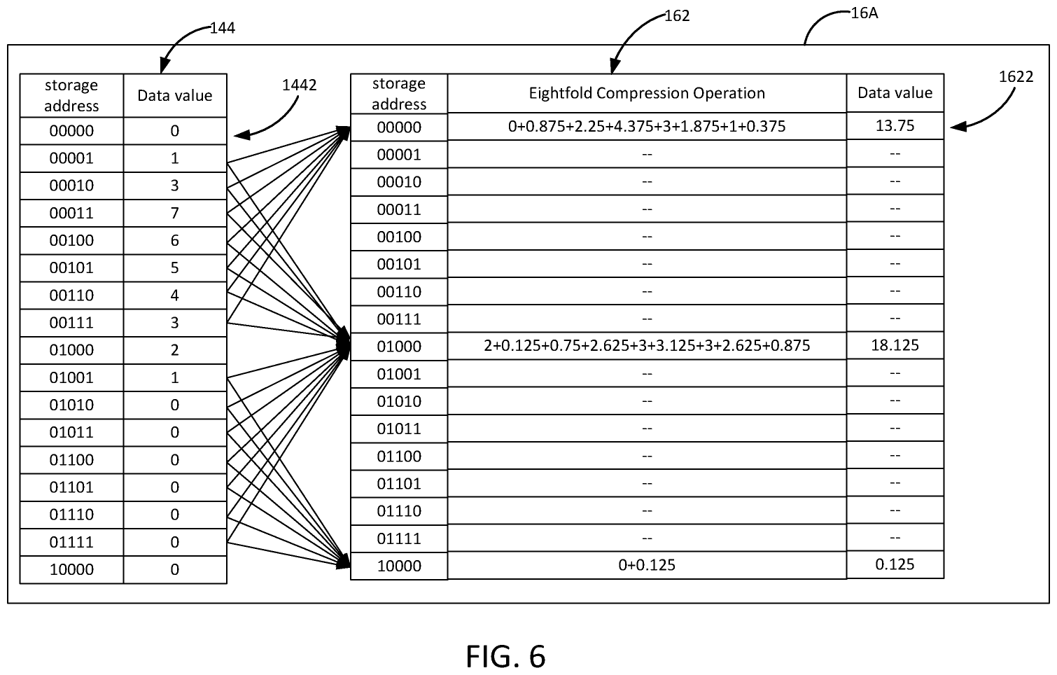

As shown in FIG. 6, the difference between FIG. 5 and FIG. 6 is that the operation processing unit 16 in FIG. 5 compresses and operates the plurality of first item data 144 by two times while the one in FIG. 6 by 8 times. Based on the eightfold compression, the plurality of first operation data 162 requires 3 bits for storing the integer item and 3 bits for the decimal items. Thereby, after eightfold compression, each item datum is 16 bits. Eightfold compression compresses 16384 item data to 2048 item data approximately. Thereby, 163840 bits of data are compressed to 32768 bits of data approximately. Namely, the compression ratio of address amount is 20%, sparing 80% storage addresses. For the compression ratio of address amount, the eightfold compression increases 5 times (namely, 1/(20%)=5) of the range detection data 142. That is to say, the detection range may be increased by 5 times. According to FIG. 5 and FIG. 6, if the compression ratio is lower, the detection range P will be more. In other words, the compression ratio of the address amount of the plurality of first item data 144 is inversely proportional to the detection range P. According to the above description, the compression operation according to the present application changes the compression ratio of the address amount. As shown in FIG. 2, the numbers of bars in the detection histogram 18 and the storage histogram 22 are different. Since the center of mass C is invariant, no detection distortion will occur after decompression operation of the stored data D is performed. In addition, the address amounts between the first storage address 1442 of the plurality of first item data 144 and the second storage address 1622 of the plurality of first operation data 162 form multiple mapping relations for different ratios.

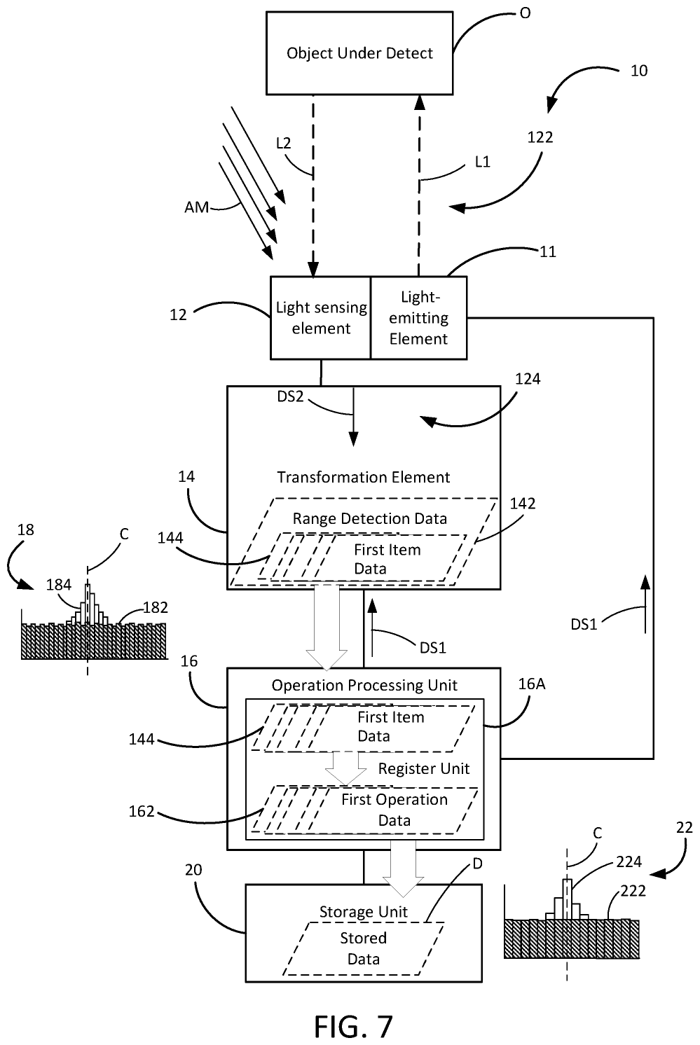

Please refer to FIG. 7, which shows a schematic diagram of signal transmission of the range detection device according to another embodiment of the present application. According to the present embodiment, in addition to detecting the reflection light L2, the optical sensing element 12 will further detect the ambient light AM, Thereby, the electrical signal of receiving detection DS2 includes the background noise of the ambient light AM and the real detection signal. Then when the transformation element 14 generates the range detection data 142 according to the electrical signal of reference DS1 and the electrical signal of receiving detection DS2, the range detection data 142 include the data corresponding to the background noise. Consequently, the plurality of first item data 144 partly or fully include a plurality of background values corresponding to the background noise and a plurality of measurement values corresponding to the actual detection signals.

As shown in FIG. 7, the difference with FIG. 2 is that the detection histogram 18 in FIG. 7 further includes a plurality of background values 182 and a plurality of first detection values 184. The storage histogram 22 further includes a plurality of first background values 222 and a plurality of second detection values 224. According to the present embodiment, since the optical sensing element 12 detects the ambient light AM, the electrical signal of reference DS1 and the electrical signal of receiving detection DS2 include the background noise. Thereby, according to the present embodiment, the corresponding detection histogram 18 of the range detection data 142 include the plurality of first background values 182 and the plurality of first detection values 184. The plurality of background values 182 are the so-called background noise. The stored data D stored to the storage unit 20 at last also correspond to the storage histogram 22. Thereby, the stored data D also correspond to the plurality of second background values 222 and the plurality of second detection values 224. In addition, the average value of the plurality of first background values 182 and the plurality of second background values 222 is inversely proportional to the ratio of the address amount of the plurality of first storage addresses 1422 of the plurality of first item data 144 to the address amount of the plurality of second storage addresses 1622 of the plurality of first operation data 162. In other words, the plurality of first background values 182 and the plurality of second background values 222 are inversely proportional to the compression ratio of the address amount of the plurality of first operation data 162.

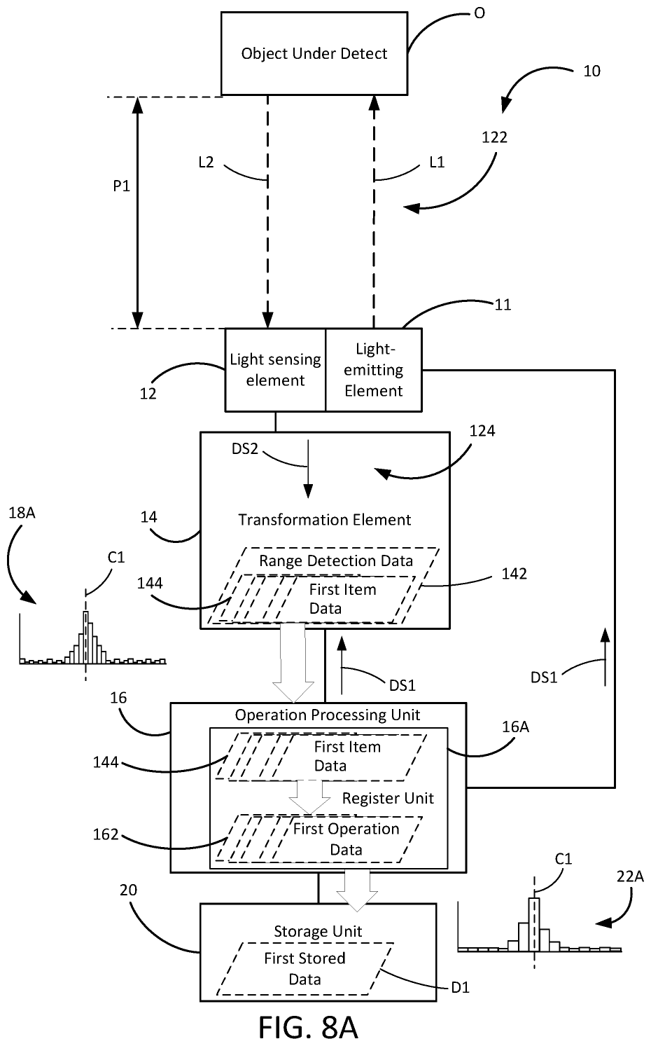

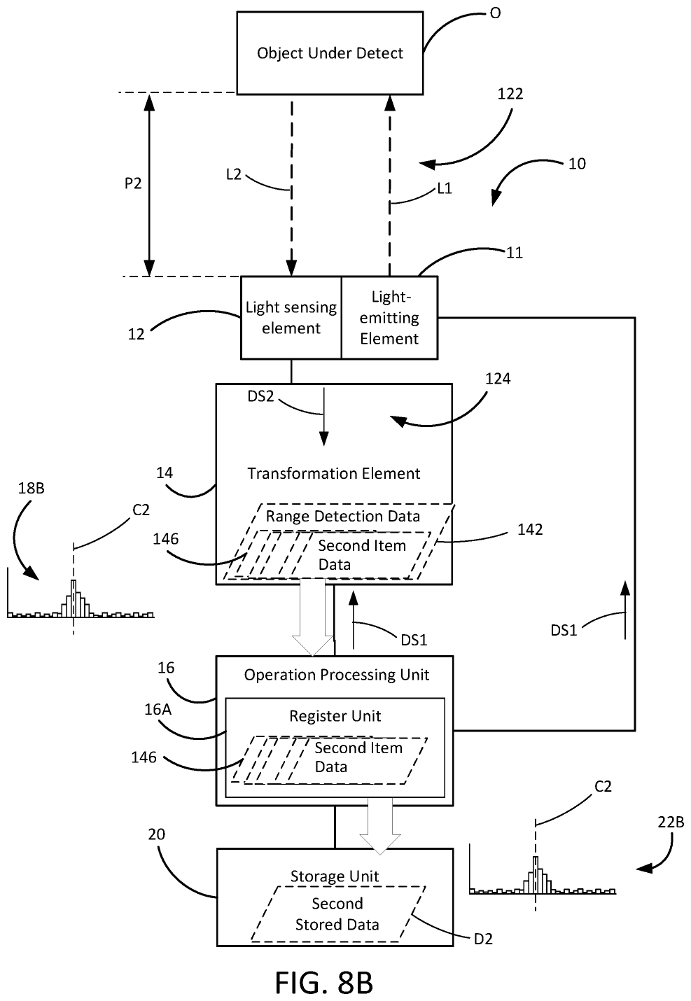

Furthermore, please refer to FIG. 8A and FIG. 8B, which show schematic diagrams of signal transmission of the range detection device according to another embodiment of the present application. The difference with FIG. 7 is that the operation processing unit 16 in FIG. 8A performs the compression operation according to a first detection range P1. The operation processing unit 16 in FIG. 8B does not perform the compression operation if a second detection range P2 is smaller than the first detection range P1. To elaborate, FIG. 8A is the same as FIG. 7. The operation processing unit 16 performs the compression operation according to the plurality of first item data 144 of the range detection data 142 of the first detection range P1 and stores as first stored data D1. Thereby, a corresponding first detection histogram 18A of the first stored data D1 is equivalent to the detection histogram 18 according to the previous embodiment. In other words, the operation processing unit 16 operates the plurality of first item data 144 in the register unit 16A to give the plurality of first operation data 162.

As shown in FIG. 8B, the operation processing unit 16 stores a plurality of second item data 146 of the range detection data 142 of a second detection range P2 as second stored data D2. Since the second detection range P2 is smaller than the first detection range P1. In addition, the correspond storage address amount of the plurality of second item data 146 is smaller than the correspond storage address amount of the plurality of first detection data 144, namely, the corresponding second detection range P2 of the plurality of second item data 146 is closer to the optical sensing device 12, a corresponding second detection histogram 18B of the plurality of second item data 146 is smaller than the corresponding first detection histogram 18A of the plurality of first item data 144. Likewise, a corresponding second storage histogram 22B of the plurality of second stored data D2 is smaller than the corresponding first storage histogram 22A. Besides, a first center of mass C1 of the first storage histogram 22A is different from a second center of mass C2 of the second storage histogram 22B. The first center of mass C1 corresponds to the first detection range P1; the second center of mass C2 corresponds to the second detection range P2. Thereby, the range detection device 10 according to the present application may detect the object under detect O at different detection ranges. The range detection device 10 may determine whether to perform compression according to different detection range.

To sum up, the present application provides a range detection device and a method for range detection thereof. First, an optical sensing element receives a reflected signal of external light signal for triggering a transformation element to generate an electrical signal of receiving detection. The transformation element generates range detection data to an operation processing unit according to the electrical signal of receiving detection and an electrical signal of reference. The operation processing unit compresses and operates a plurality of first item data of the range detection data and generates a plurality of first operation data. The plurality of first operation data are stored as stored data of the range detection device. In addition, the plurality of first item data correspond to a plurality of first storage addresses of the range detection device. The plurality of first operation data correspond to a plurality of second storage addresses of the range detection device. A first address amount of the plurality of first storage addresses is greater than a second address amount of the plurality of second storage addresses. Thereby, according to the present application, more storage addresses will be spared and hence extending the detection range of the range detection device.

Accordingly, the present application conforms to the legal requirements owing to its novelty, non-obviousness, and utility. However, the foregoing description is only embodiments of the present application, not used to limit the scope and range of the present application. Those equivalent changes or modifications made according to the shape, structure, feature, or spirit described in the claims of the present application are included in the appended claims of the present application.

1. A method for range detection, applied to a range detection device, said range detection device comprising an optical sensing element, a transformation element, and an operation processing unit, comprising steps of:
said optical sensing element receiving a reflected signal of external light signal and triggering said transformation element to generate an electrical signal of receiving detection;
said transformation element generating range detection data to an operation processing unit according to said electrical signal of receiving detection and an electrical signal of reference, and said range detection data including a plurality of first item data; and
said operation processing unit compressing and operating said plurality of first item data and generating a plurality of first operation data and storing as stored data, said plurality of first item data corresponding to a plurality of first storage addresses of said range detection device, said plurality of first operation data corresponding to a plurality of second storage addresses of said range detection device, and a first address amount of said plurality of first storage addresses greater than a second address amount of said plurality of second storage addresses.

2. The method for range detection of claim 1, wherein the ratio of said first address amount to said second address amount corresponds to a detection range of said optical sensing element.

3. The method for range detection of claim 2, wherein the ratio of said first address amount to said second address amount forms multiple mapping relations for different ratios.

4. The method for range detection of claim 1, wherein said step of said operation processing unit compressing and operating said plurality of first item data and generating a plurality of first operation data and storing as stored data, said operation processing unit further stores said stored data in a storage unit.

5. The method for range detection of claim 1, wherein said plurality of first item data correspond to a center of mass; and said plurality of operation data correspond to said center of mass.

6. The method for range detection of claim 1, wherein said range detection data further comprise a plurality of second item data; said operation processing unit stores said plurality of second item data directly; and a corresponding first range of said plurality of first item data is greater than a corresponding second range of said plurality of second item data.

7. The method for range detection of claim 1, wherein said plurality of first item data comprise a plurality of measurement values and a plurality of background values corresponding to said electrical signal of receiving detection; and the average value of said plurality of background values is inversely proportional to a compression ratio of address amount between said plurality of first item data and said plurality of first operation data.

8. The method for range detection of claim 1, wherein said electrical signal of reference is generated by said operation processing unit or an external controller.

9. The method for range detection of claim 1, wherein said plurality of first operation data include at least one bit for storing an integer term and at least one bit for storing a decimal term.

10. A range detection device, comprising:
an optical sensing element, configured to receiving a reflected signal of external light signal;
a transformation element, coupled to said optical sensing element, generating an electrical signal of receiving detection when said optical sensing element receiving said reflected signal of external light signal, generating range detection data according to said electrical signal of receiving detection and an electrical signal of reference, and said range detection data including a plurality of first item data; and
an operation processing unit, compressing and operating said plurality of first item data and generating a plurality of first operation data and storing as stored data, said plurality of first item data corresponding to a plurality of first storage addresses of said range detection device, said plurality of first operation data corresponding to a plurality of second storage addresses of said range detection device, and a first address amount of said plurality of first storage addresses greater than a second address amount of said plurality of second storage addresses.

11. The range detection device of claim 10, wherein a ratio of said first address amount to said second address amount corresponds to a detection range of said optical sensing element.

12. The range detection device of claim 11, wherein the ratio of said first address amount to said second address amount forms multiple mapping relations for different ratios.

13. The range detection device of claim 10, wherein said operation processing unit further stores said stored data in a storage unit.

14. The range detection device of claim 10, wherein said plurality of first item data correspond to a center of mass; and said plurality of operation data correspond to said center of mass.

15. The range detection device of claim 10, wherein said range detection data further comprise a plurality of second item data; said operation processing unit stores said plurality of second item data directly; and a corresponding first range of said plurality of first item data is greater than a corresponding second range of said plurality of second item data.

16. The range detection device of claim 10, wherein said plurality of first item data comprise a plurality of measurement values and a plurality of background values corresponding to said electrical signal of receiving detection; and the average value of said plurality of background values is inversely proportional to a compression ratio of address amount between said plurality of first item data and said plurality of first operation data.

17. The range detection device of claim 10, wherein said electrical signal of reference is generated by said operation processing unit or an external controller.

18. The range detection device of claim 10, wherein said plurality of first operation data include one or more bit for storing an integer term and at least one bit for storing a decimal term.
